(19) United States
(12) Patent Application Publication
(10) Pub. No.: US 2012/0012426 A1
(43) Pub. Date: Jan. 19, 2012

(54) Portable elevator

(76) Inventors: Shahriar Rahmani, Bothell, WA (US); Cynthia Rahmani, Bothell, WA (US)

(21) Appl. No.: 12/805,139

(22) Filed: Jul. 14, 2010

(51) Int. Cl. B66B 9/16

(52) U.S. Cl. 187/240

(57) ABSTRACT

A portable elevator for use as a substitute for a ladder is disclosed. The elevator includes a track having a pair of upright, guide rails. A movable platform is slidably secured to the guide rails and is adapted for up and down movement upon the guide rails. A winch is affixed to the bottom of the track for moving the platform upon the guide rails. The winch has an electric motor and a drum that is rotated by the motor. A stationary pulley is secured to the top of the track, and a movable pulley is secured to the top of the movable platform. A cable is wound upon the drum and extends from the drum and around the stationary pulley and the movable pulley. The energization of the motor selectively draws the cable onto the drum to elevate the movable platform upon the track.

### FIELD OF THE INVENTION

The present invention relates generally to elevators and, more particularly, to portable elevators having winding drums.

### BACKGROUND OF THE INVENTION

Workers in the construction trades are frequently called upon to access areas well above the height of a man. To gain such access, ladders are employed on occasion. A ladder is a structure of wood, metal, or rope, commonly consisting of two sidepieces between which a series of rungs are set at suitable distances. The rungs serve as steps for a user while the sidepieces act as handrails. Unfortunately, safely scaling a ladder requires two free hands to grasp the sidepieces; so, critical tools must often be left behind while workers ascend or descend ladders. Thus, the use of ladders can slow the progress of some jobs.

### SUMMARY OF THE INVENTION

In light of the problems associated with ladders, it is a principal object of the present invention to provide a portable elevator that selectively raises users, equipment, or supplies to a desired height in a virtually effortless and hands-free manner. The elevator permits a user to take the most direct route to a raised area without the need to make multiple trips to recover the goods needed to perform a task.

It is still another object of the invention to provide a portable elevator of the type described that requires neither prolonged training nor special tools to use. The elevator is easy to set up and take down, requiring just a few minutes of instruction to master.

It is an object of the invention to provide improved features and arrangements thereof in a portable elevator for the purposes described which is lightweight in construction, inexpensive to manufacture, and fully dependable in use.

Briefly, our portable elevator achieves the intended objects by featuring a track having a pair of guide rails. A movable platform is secured to the guide rails and is adapted for up and down movement upon the guide rails. A winch is affixed to the bottom of the track for moving the platform. The winch has an electric motor and a drum that is rotated by the motor. A stationary pulley is secured to the top of the track, grid a movable pulley is secured to the top of the movable platform. A cable is wound upon the drum and extends from the drum and around the stationary pulley and the movable pulley. The energization of the motor selectively draws the cable onto the drum and elevates the movable platform.

The foregoing and other objects, features, and advantages of our invention will become readily apparent upon further review of the following detailed description of the portable elevator illustrated in the accompanying drawings.

### BRIEF DESCRIPTION OF THE DRAWINGS

The present invention may be more readily described with reference to the accompanying drawings, in which:

FIG. 1 is a front view of our portable elevator.

FIG. 2 is an enlarged, horizontal, cross-sectional view of a portion of the guide track of our portable elevator.

FIG. 3 is a schematic wiring diagram showing an electrical circuit for operating the winch of our portable elevator.

FIG. 4 is a cross-sectional view of our portable elevator taken along line 4-4 of FIG. 1 with the portable elevator being inclined against a building structure for use.

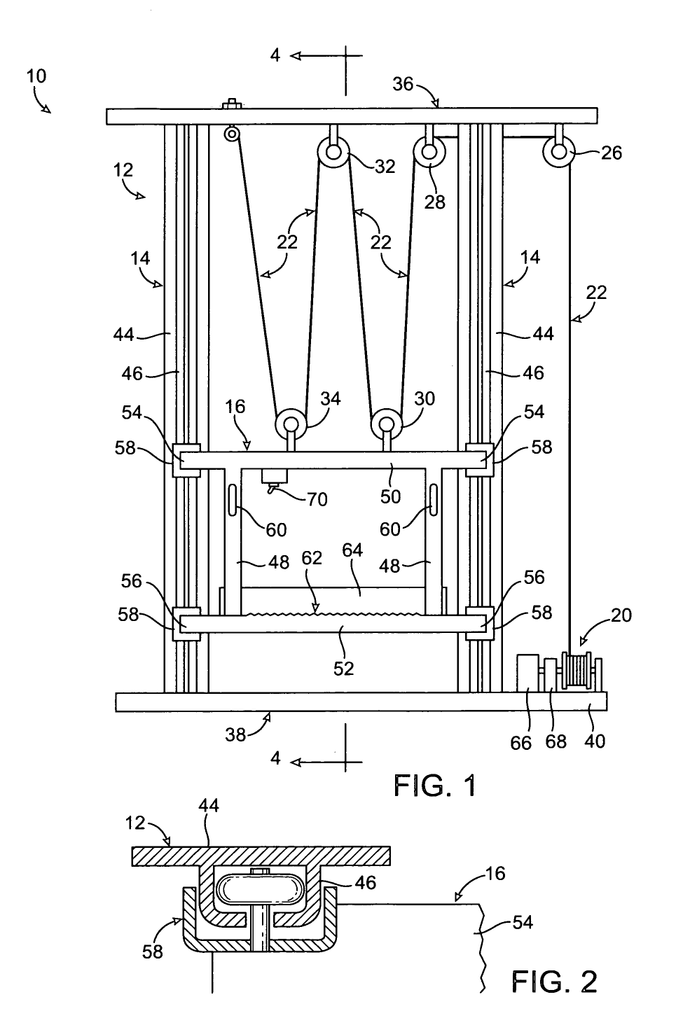

Similar reference characters denote corresponding features consistently throughout the accompanying drawings.

### DETAILED DESCRIPTION OF THE PREFERRED EMBODIMENT

Referring now to the FIGS., a portable elevator, constructed in accordance with the present invention, is shown at 10. The elevator 10 includes a track 12 having a pair of upright, guide rails 14. A movable platform 16 slides up and down on the rails 14 for selectively elevating a person, trade tools, and other things, to a user-selected height above the ground 18. A winch 20 is affixed to the bottom of the track 12 and is employed to selectively lift the platform 16 by retracting a cable 22 onto a drum 24. The cable 22 extends over a number of pulleys 26, 28, and 32 secured to the top of the track 12 and a number of pulleys 30 and 34 secured to the top of the platform 16.

The track 12 includes a pair of upright, guide rails 14 connected together in a spaced-apart, parallel relationship by a horizontal, top brace 36 and a horizontal, bottom brace 38. As shown, the top brace 36 is affixed at right angles to the respective tops of the guide rails 14. The bottom brace 38, however, is affixed at right angles to the respective bottoms of the guide rails 14. Preferably, the braces 36 and 38 are of equal length and project outwardly from the guide rails 14 so as to define free ends or feet, as at 40, that distribute loads carried by the elevator 10 to the ground 18 and a vertical supporting surface 42 and minimize the likelihood of the elevator 10 tipping sideways.

Each of the guide rails 14 has a stiffening plate 44 that abuts the braces 36 and 38. A C-shaped, channel member 46 is affixed to the center of each stiffening plate 44 and extends the length thereof. For added strength, a stiffening plate 44 and channel member 46 are integrally formed as a single unit.

The movable platform 16 is shaped somewhat like the track 12. The platform 16, thus, includes a pair of upright handlebars 48 connected together in a spaced-apart, parallel relationship by a horizontal, top spar 50 and a horizontal, bottom spar 52. The top spar 50 is affixed at right angles to the respective tops of the handlebars 48, and the bottom spar 52 is affixed at right angles to the respective bottoms of the handlebars 48. The spars 50 and 52 are of equal length and project outwardly from the handlebars 48 to define free ends shown respectively at 54 and 56. One of four bearing assemblies 58 is affixed to each of the free ends 54 and 56. The bearing assemblies 58 are adapted to engage, and slide within, the channel members 46.

The platform 16 is configured to enhance safety. First, a C-shaped handgrip 60 is affixed to and extends rearwardly from the top of each handlebar 48 for a user to grasp. Next, the bottom spar 52 has a width of several inches, similar to that of a ladder tread, so that a user can comfortably place his feet upon the platform 16 as it is moved up and down. The bottom spar 52 is also provided with a textured, non-slip, top surface 62 to reduce the likelihood of a fall from the platform 16. To further minimize the likelihood of a fall, a kick plate 64 is affixed to the front of the spar 52.

The winch 20 operates to move the platform 16 up and down on the track 12 and is affixed to one of the feet 40 at the bottom of the track 12. The winch 20 includes an electric motor 66 that is connected through a torque-improving gearbox 68 to a rotating drum 24. A flexible cable 22 is wound on the drum 24.

The motor 66 selectively can be run in either a “negative” direction or a “positive” manner. By energizing the motor 66 in a negative sense, the cable 22 is wound onto the drum 24. By energizing the motor 66 in a positive sense, the cable 22 is unwound from the drum 24. When the cable 22 is wound onto the drum 24, the platform 16 is raised on track 12. Of course, when the cable 22 is unwound from the drum 24, the platform 16 is lowered.

A block and tackle system is formed by the routing of the cable 22 around the pulleys 26-34. In the system shown, it can be seen that the cable 22 extends upwardly from each of the moving pulleys 30 and 34 allows the platform 16 to be lifted with only one-fourth the force needed to lift the platform 16 without the assistance of the pulleys 30 and 34. Although the lifting force is reduced, the drum 24 will need to wind onto itself a length of cable 22 that is four times the distance that the platform 16 is lifted.

In the elevator 10, the lifting force is directed downwardly, in a direction opposite to the movement of the platform 16. Together, the pulleys 26 and 28 serve to redirect the lifting force downward to the winch 20 and do not change the advantage (the weight lifted divided by the lifting force) of the block and tackle system. The advantage of the system shown herein remains four.

The addition of pulleys to the ideal block and tackle system described above can yield an increase of advantage in the elevator 10. For real pulleys, friction between the cable 22 and the pulleys will increase as more pulleys are added to the point that no advantage is obtained. This eventuality limits the number of pulleys usable in the elevator 10. Regardless of the numbers of fixed and movable pulleys selected as a matter of design choice for use in the elevator 10, they can be encased in single housings (not shown) for efficient construction.

A dual-throw switch 70 affixed to the top spar 50 is employed to operate the winch 20. The switch 70 is easily reached by the hand of a user of the elevator 10 and is manually thrown. By operation of the switch 70, the energized winch 20 can either raise or lower the platform 16 and its burden. The deenergized winch 20, having an internal brake and being of a sort that will not permit the drum 24 to rotate when the motor 66 is deenergized, maintains the platform 16 at a selected location on the elevated track 12.

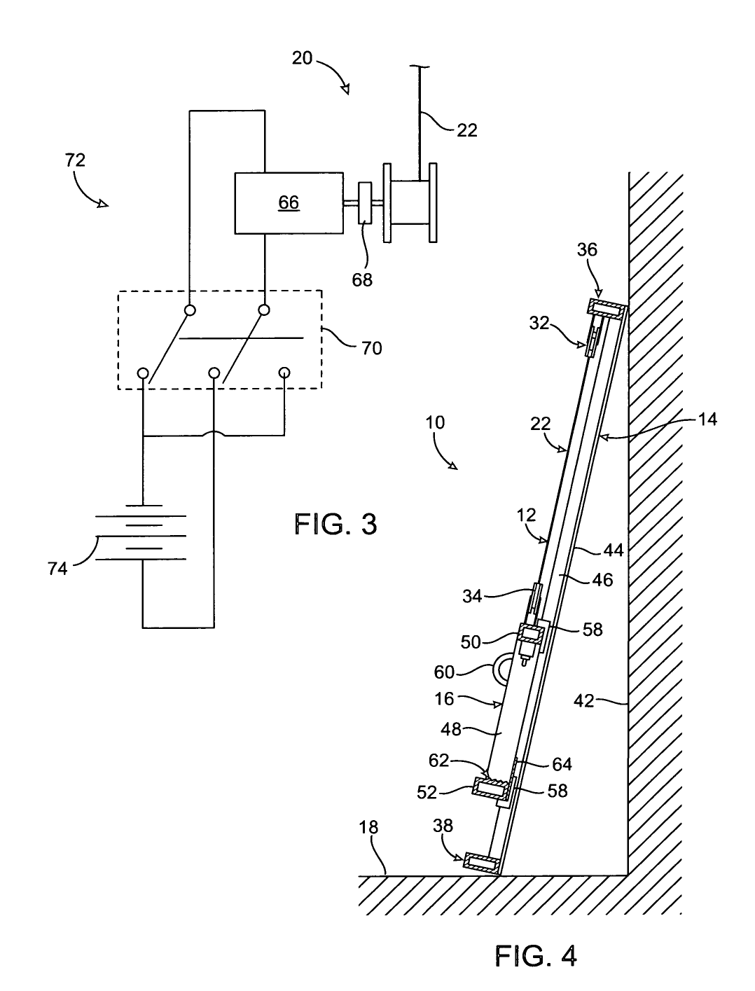

By manually moving the switch 70 to a first position, an electrical circuit 72 is closed as is illustrated schematically in FIG. 3. The closed circuit 72 connects the motor 66 to an electrical current source 74, like a storage battery, in a manner that causes the motor 66 to rotate the drum 24 in a “negative” sense, winding up the cable 22 onto itself and raising the platform 16 on the track 12. Maintaining the switch 70 in the first direction permits the platform 16 to rise to the top of the track 12 with the top brace 36 serving as a stop to upward movement of the platform 16. Opening the circuit 72, by moving the switch 70 to disconnect the current source 74 from the motor 66, “parks” the platform 16 at a selected location on the track 12.

Fully moving the switch 70 to the right to a second position closes the electrical circuit 72 in a different way. Now, the closed circuit connects the motor 66 to the current source 74 in a way that causes the motor 66 to rotate the drum 24 in a “positive” sense, unwinding the cable 22 and lowering the platform 16 on the track 12. Maintaining the switch 70 in the second direction permits the platform 16 to move to the bottom of the track 12 with the bottom brace 38 serving as a stop to continued downward movement of the platform 16. Opening the circuit 72, by moving the switch 70 from the second position to its starting position, “parks” the platform 16 at a selected location on the track 12.

Although it is believed that the electrical circuit 72 provides a cost-effective and practical means for controlling the winch 20, there are other means for controlling the winch 20 that can be employed in the elevator 10. For example, the winch 20 can be operated via a remote control mechanism (not shown) having a radio transmitter mounted on the platform 16 and a radio receiver joined to the track 12 adjacent the winch 20. In a conventional manner, the transmitter broadcasts an electrical operations signal to the receiver. The receiver causes a servo to close a dual-throw switch to deliver an energization current to the motor 66 that rotates the drum 24 in either direction.

The use of the elevator 10 is straightforward. First, track 12 is leaned at a safe incline against the side of a building or other structure in the manner of a ladder. (If desired, the track 12 can be fixed in place by suitable anchors, not shown.) Next, with the platform 16 lowered on the track 12, a user steps onto the bottom spar 52, toes the kick plate 64, and grasps the handgrips 60. Afterward, the user moves the switch 70 to its first position thereby energizing the winch 20 and elevating the platform 16. When the platform 16 has reached a desired height, the switch 70 is toggled to its neutral position to stop the platform 16. The user can now step off the platform 16 onto the structure supporting the track 12 or perform work on the structure. When the task is completed, the user can lower the platform 16 and himself to the bottom of the track 12 by toggling the switch 70 to its second position. Since the elevator 10 eliminates climbing of the sort done with ladders, users of the elevator 10 do not become as fatigued while working and should accomplish more with fewer injuries.

While the portable elevator 10 has been described with a high degree of particularity, it will be appreciated by those skilled in the field that modifications can be made to it. For example, an additional, failsafe, braking mechanism can be carried by the platform 16 to ensure that the platform 16 does not fall from a raised position in the unlikely event that the cable 22 breaks or another part of elevator 10 fails. Therefore, it is to be understood that the present invention is not limited solely to the elevator 10, but encompasses any and all elevators within the scope of the following claims.

We claim:

1. A portable elevator, comprising:
a track having a pair of upright, guide rails;
a movable platform being slidably secured to said guide rails and being adapted for up and down movement upon said guide rails;
a winch being affixed to the bottom of said track for moving said platform upon said guide rails, said winch including:
an electric motor;
a drum being secured to said motor and being adapted for rotation by said motor;
a stationary pulley being secured to the top of said track;
a movable pulley being secured to the top of said movable platform; and,
a cable being wound upon said drum and extending from said drum and around said stationary pulley and said movable pulley whereby the energization of said motor selectively draws said cable onto said drum to elevate said movable platform upon said track.

2. The portable elevator according to claim 1 wherein said movable platform includes;
a pair of handlebars being vertically oriented and spaced apart;
a horizontal, top spar connecting the tops of said handlebars together and projecting outwardly therefrom so as to define a pair of first free ends;
a horizontal, bottom spar connecting the bottoms of said handlebars together and projecting outwardly therefrom so as to define a pair of second free ends;
a pair of first bearing assemblies, each of said first bearing assemblies being affixed to a respective one of said pair of first free ends and being slidably engaged with a respective one of said guide rails; and,
a pair of second bearing assemblies, each of said second bearing assemblies being affixed to, a respective one of said pair of second free ends and being slidably engaged with a respective one of said guide rails.

3. The portable elevator according to claim 2 wherein said movable platform further includes:
a pair of handgrips, each of said handgrips being affixed to a respective one of said handlebars; and,
a kick plate being affixed to the front of said bottom spar.
